(19) United States
(12) Patent Application Publication
(10) Pub. No.: US 2008/0170973 A1
(43) Pub. Date: Jul. 17, 2008

(54) Catalytic Filter For Filtering a Gas Comprising a Coating and/or a Joint With Controlled Porosity

(75) Inventors: Patricia Andy, Les Taillades (FR); Sebastien Bardon, La Ciotat (FR); Anthony Briot, Chemin du Moulin (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN CTR DE RECH. ET DETUDES EUROPEAN SAS, Courbevoie (FR)

(21) Appl. No.: 11/910,528

(22) PCT Filed: Apr. 7, 2006
(86) PCT No.: PCT/FR2006/050314

§ 371 Date: Mar. 25, 2008

(30) Foreign Application Priority Data
Apr. 8, 2005 (FR) 0550914
Jun. 14, 2005 (FR) 0551594

(51) Int. Cl. B01D 53/86; B32B 38/08

(52) U.S. Cl. 422/177; 156/280

(57) ABSTRACT

The invention concerns a catalytic filter for depolluting a gas loaded with soot particles and gaseous pollutants, obtained by impregnating in a catalytic solution a filtering structure formed by an assembly of honeycomb-type monolithic elements, wherein the porosity of the cement used as coating and/or as joint and/or as plug is less than the porosity of the material constituting said element(s).

The invention relates to the field of particle filters used in an exhaust line of an engine for removing the soot typically produced by combustion of a diesel fuel in an internal combustion engine. More precisely, the invention relates to a particle filter, said filter comprising, in addition, a material giving it catalytic properties, and also to a process for preparing it.

The filtration structures for the soot contained in internal combustion engine exhaust gases are well known in the prior art. These structures most frequently have a honeycomb structure, one of the faces of the structure allowing the intake of the exhaust gases to be filtered and the other face the discharge of the filtered exhaust gases. The structure comprises, between the intake and discharge faces, a set of adjacent ducts or channels with axes parallel with one another separated by porous filtration walls, which ducts are stopped at one or other of their ends to delimit inlet chambers opening on the intake face and outlet chambers opening on the discharge face. For a good seal, the peripheral part of the structure is surrounded by a cement, referred to as a coating cement in the remainder of the description. The channels are alternately stopped in an order such that the exhaust gases, as they pass through the honeycomb body, are forced to pass through the sidewalls of the inlet channels in order to join the outlet channels. In this way, the particles or soot are deposited and accumulate on the porous walls of the filtering body. Advantageously, the filtering bodies are made of a porous ceramic material, for example corderite or silicon carbide.

In a known manner, during its use, the particle filter is subjected to a succession of filtration phases (accumulation of soot) and regeneration phases (removal of soot). During the filtration phases, the soot particles emitted by the engine are retained and deposited inside the filter. During the regeneration phases, the soot particles are burnt inside the filter, in order to restore its filtration properties thereto. The porous structure is then subjected to intense thermal and mechanical stresses, which may cause micro-cracks that are likely over time to cause a severe loss of the filtration abilities of the unit, or even its complete deactivation. This phenomenon is particularly observed on large-diameter monolithic filters.

To solve these problems and increase the service life of the filters, more complex filtration structures have more recently been proposed that combine several honeycomb monolithic elements in a filtering block. The elements are usually assembled together by bonding using a cement of ceramic nature, referred to in the remainder of the description as a joint cement. Examples of such filtering structures are, for example, described in Patent Applications EP 816 065, EP 1 142 619, EP 1 455 923 or else WO 2004/090294.

It is known that in this type of structure, in order to ensure a better relaxation of the stresses, the thermal expansion coefficients of the various parts of the structure (filtering elements, coating cement, joint cement) must be approximately of the same order. Therefore, said parts are synthesized based on one and the same material, most often silicon carbide SiC or corderite. This choice makes it possible, moreover, to homogenize the heat distribution during regeneration of the filter. The expression “based on one and the same material” is understood in the sense of the present description to mean that the material is composed of at least 25 wt %, preferably of at least 45 wt % and more preferably of at least 70 wt % of said material.

The soot filters or porous filtration structures as described previously are mainly used on a large scale in pollution control devices for the exhaust gases of a diesel engine.

In addition to the problem of treating soot, the conversion of gas-phase polluting emissions (that is to say mainly nitrogen oxides (NOₓ) or sulfur oxides (SOₓ) and carbon monoxide (CO), or even unburnt hydrocarbons) into less harmful gases (such as gaseous nitrogen (N₂) or carbon dioxide (CO₂)) requires an additional catalytic treatment.

According to a first technology, to remove all the pollutants, the exhaust line of an internal combustion engine comprises, in series, a catalytic purification member and a particle filter.

The catalytic purification member, generally having an open honeycomb structure, is suitable for treating gas-phase pollutants, whereas the particle filter is suitable for removing the soot particles emitted by the engine. Besides the complexity of implementing this solution and its cost, the succession of filtering elements in the exhaust line is however responsible for a not insignificant pressure drop in said line, capable of influencing the engine performance.

To solve these problems, it has been sought to transfer the catalytic function to a monolithic-type particle filter. According to the processes conventionally used, the honeycomb structure is impregnated with a solution comprising the catalyst or a catalyst precursor.

Such processes generally comprise a step of immersion either in a solution containing a catalyst precursor or the catalyst dissolved in water (or another solvent), or a suspension of catalytic particles in water. One example of such a process is described by Patent U.S. Pat. No. 5,866,210. According to this process, the application of an underpressure to the other end of the filter subsequently enables the rise of the solution in the structure and consequently the coating of the inner walls of the honeycomb structure.

According to other embodiments of the process for impregnating honeycomb filters, said impregnations may be obtained by pumping, by application of a vacuum or under the pressure of the liquid comprising the impregnation solution, over at least one end of the monolith. Usually the processes described are characterized by a combination of these various techniques, during successive steps, the final step allowing the removal of the solution in excess in the filter by introduction of pressurized air or by suction. One of the main objectives sought by the implementation of these processes is the production of a uniform coating of the catalyst on, or even inside, at least one part of the porous walls of the channels that make up the inner part of the structure and through which the exhaust gases pass through.

Such processes, and also the devices for their implementation, are for example described in Patent Applications or Patents US 2003/044520, WO 2004/091786, U.S. Pat. No. 6,149,973, U.S. Pat. No. 6,627,257, U.S. Pat. No. 6,478,874, U.S. Pat. No. 4,609,563, U.S. Pat. No. 4,550,034, U.S. Pat. No. 6,599,570, U.S. Pat. No. 4,208,454 or else U.S. Pat. No. 5,422,138. Whichever method is used, the cost of the catalysts deposited, which usually contain precious metals from the platinum group (Pt, Pd, Rh) on an oxide support represents a not insignificant part of the overall cost of the impregnation process. It is therefore important according to the invention not only that the catalyst is deposited uniformly on the walls of the filtration channels, but also that a minimal part of it is deposited on the parts of the honeycomb structure which do not come into direct contact with the gases to be filtered or the soot. Said parts are mainly the coating cement for a monolithic structure with the addition of the joint cement in the case of a filtering block as described previously, that is to say combining several honeycomb monolithic elements and to a lesser extent the cement used for the plugs alternately stopping the channels.

The subject of the present invention is thus to limit the amount of catalyst present on the parts of the structure that do not come into direct contact with the gas to be filtered or the soot, during a process for impregnating a particle filter having a honeycomb structure.

More precisely, according to a first aspect, the present invention relates to a process for obtaining a filter for filtering a gas loaded with soot particles and pollutants in the gas phase such as carbon monoxide CO, nitrogen oxides NOₓ, sulfur oxides SOₓ, hydrocarbons HC, said process comprising the steps of:

a) manufacturing a first structure comprising:
a central part comprising a plurality of filtering elements as a honeycomb connected together by a joint cement, said element or elements comprising a set of adjacent ducts or channels with axes parallel with one another separated by porous walls, which ducts are stopped by plugs at one or other of their ends to delimit inlet chambers opening on a gas intake face and outlet chambers opening on a gas discharge face, in such a way that the gas passes through the porous walls; and
a peripheral part made up of a coating cement protecting said element or elements, the porosity of the joint cement and/or of the coating cement and/or of the cement forming the plugs being less than the porosity of the material making up said walls; and

b) impregnating said structure with a solution containing a catalyst precursor or the catalyst dissolved in a solvent such as water, that is to say a suspension of catalyst particles in a solvent such as water.

Preferably, said elements, the coating cement, the joint cement and the plugs are based on one and the same ceramic material, preferably based on silicon carbide SiC.

Advantageously, the porosity of the cement used for the coating and/or for the joint and/or for the plugs is at least 5%, preferably at least 10% and more preferably at least 15%, or even 20%, lower than the porosity of the filtering elements. In the meaning of the present description, this difference of 5, 10, 15 or 20% is calculated based on the percentage difference in porosity between the filtering element or elements and the coating or joint cement, relative to the percentage porosity of the filtering element or elements in question.

Generally, the porosity of the honeycomb filtering elements is between 30% and 70%, preferably between 35% and 60%.

Typically, the porosity of the cement used for the coating and/or for the joint and/or for the plugs is between 20% and 60%, preferably between 25% and 45%.

According to the invention, impregnation of the structure may be carried out by any method known in the art and especially by pumping the solution through the structure, by application of a vacuum or an underpressure or under the pressure of the liquid comprising the impregnation solution over at least one end of the structure. A better impregnation is generally obtained by a combination of these various techniques, during successive steps, usually a final step allowing the removal of the solution in excess in the filter by suction or by introduction of pressurized air.

According to the invention, the impregnation step may be carried out according to the processes and/or devices known in the prior art and especially according to one of the processes or devices described in the aforementioned patents or patent applications.

The porosity of the cement being used for the coating and/or for the joint and/or for the plugs may be adjusted according to several methods of preparation:

According to a first method, during the step of preparing the cement and before its application to the filtering part, the composition of the cement and/or the particle size distribution of the grains being incorporated into the composition of the cement and/or the amount of water mixed with grains is adjusted and also that of the other liquid ingredients, to obtain the desired porosity. By way of example, it is possible, according to the invention, to use dynamic compaction models that make it possible to obtain maximum compactness of the cement by playing especially on the relative proportions of the particle size grades of the various powders used.

According to another possible method, the porosity of the coating and/or joint cements and/or the plugs is adjusted by introducing, during the preparation step, a filler, of which the size is adjusted to that of the pores of the cement. The filler, by occupying at least partly, the pores of the cement, thus prevents the catalyst precursors or the catalyst from infiltrating into the porosity.

Typically, the fillers are for example organic or inorganic molecules, of which the size is approximately identical to or less than that of said precursors or said catalysts.

To further improve the effectiveness of the process, it is of course possible, without going outside the scope of the invention, to use a combination of the two preceding methods.

The invention relates, according to a second aspect, to a catalytic filter able to be obtained by the manufacturing process such as has just been described, and being characterized by a lower porosity of the cement making up the coating and/or the joints and/or the plugs relative to the porosity of the filtering element or elements, and also by the presence of a minimal amount of catalyst on said cement. The expression “minimal amount” is understood in the sense of the present description to mean a lower amount of catalyst relative to the theoretical amount of catalyst contained in a cement having the same porosity as that of the filtering elements. Preferably, the catalytic filter is characterized in that the porosity of the cement making up the coating and/or the joints and/or the plugs is at least 5%, preferably at least 10% and more preferably at least 15% lower than the porosity of the filtering element or elements.

The invention and its advantages will be better understood on reading the following examples. It is understood that these examples must not be considered, in any of the aspects described, as limiting the present invention.

### EXAMPLE 1

A filtering structure comprising a set of silicon carbide filtering elements connected by a joint cement was synthesized according to the techniques described in Patent EP 1 142 619.

Sixteen monolithic filtering elements having a square cross section were first extruded, dried then cured according to well-known techniques, for example described in EP 1 142 619. In the model described in Application EP 1 142 619, the channels of the elements are alternately plugged by plugs made from the same paste as that used for the step of extruding the monolithic elements.

A cement for the joint and the coating was then prepared by mixing:
15 wt % of an SiC powder of which the grain size was less than 10 μm;
20 wt % of an SiC powder of which the grain size was less than 50 μm;
50 wt % of an SiC powder of which the grain size was less than 200 μm;
4 wt % of a calcined alumina powder sold by Almatis;
10 wt % of a reactive alumina powder sold by Almatis;
0.9 wt % of a temporary and plasticizing binder of the cellulose type; and
0.1 wt % of a deflocculant of the NaTPP (sodium tripolyphosphate) type.

An amount of water corresponding to 10% of the weight of this mixture was added to obtain a cement of sufficient viscosity.

After assembling the monoliths by means of said cement then machining the outer surface of the structure thus obtained, said outer surface was then covered with the same cement for its coating. The assembly was re-cured at a sufficient temperature to ensure a satisfactory cohesion of the filter and its elements.

The characteristics of the crude filtration structure thus synthesized are given in Table 1.

TABLE 1
Characteristics of the crude structure
(before impregnation)

| Channel geometry | Square |
|---|---|
| Channel density | 180 cpsi (channels per square |
| | inch, 1 inch = 2.54 cm, namely |
| | about 70 channels per cm²) |
| Wall thickness | 350 μm |
| Number of elements assembled | 16 |
| Shape of the structure | Cylindrical |
| Length | 6″ (15.2 cm) |
| Volume | 2.48 liters |
| Porosity of the filtering | 47% |
| elements | |
| Porosity of the cement | 43% |
| Difference in the filtering | 8.5% |
| elements/cement relative | |
| porosity | |
| Weight % of the elements and | 80% (including 76% for the |
| plugs | elements, and 4% for the plugs) |
| Weight % of the joint cement | 13% |
| Weight % of the coating cement | 7% |

This crude structure was then immersed in a bath of an aqueous solution containing the appropriate amounts of a platinum precursor in the form of H₂PtCl₆, and a cerium oxide CeO₂ precursor (in the form of cerium nitrate) and a zirconium oxide ZrO₂ precursor (in the form of zirconyl nitrate) according to the principles described in the publication EP 1 338 322 A1. The filter was impregnated by the solution according to an implementation method similar to that described in U.S. Pat. No. 5,866,210. The filter was then dried at around 150° C. then heated to a temperature of around 600° C.

The main characteristics of the catalytic filter thus obtained are given in Table 2.

TABLE 2
Characteristics of the catalytic filter

| Filtering | Location of the catalyst | Inside the walls, around |
|---|---|---|
| elements | | the SiC grains |
| | Formulation | Pt—CeO₂—ZrO₂ |
| | BET specific surface area | 5.1 m²/g |
| | Porosity of the elements | 43% |
| Cement | Presence of catalyst on | Yes |
| | the joint cement | |
| | Presence of catalyst on | Yes |
| | the coating cement | |
| | Presence of catalyst in | Yes |
| | the joint cement | |
| | Presence of catalyst in | Yes |
| | the coating cement | |
| | Porosity | 40% |

Chemical analysis showed a total Pt concentration of 52 g/ft³ (1 g/ft³=0.035 kg/m³), that is to say a concentration of 1.82 kg/m³, or 4.5 grams spread nonhomogeneously over the various parts of the filter.

More precisely, the analysis revealed the following distribution:
0.25 wt % of platinum in the monolithic elements, that is to say 4.0 grams, including 3.8 grams in the porosity of the walls of the honeycomb elements and 0.2 grams in the plugs;
0.13 wt % of platinum in the coating cement, namely 0.25 grams, over a thickness of a few tens of μm starting from the outer surface of the cement; and
0.08 wt % of platinum in the joint cement, namely 0.25 grams, the platinum being distributed homogeneously in the entire thickness of the cement.

### EXAMPLE 2

A catalytic filter was manufactured by repeating the same steps as those in Example 1, with the difference that the cement used for the coating and the joint was prepared from the following amounts of the various constituents:
21 wt % of an SiC powder of which the grain size was less than 10 μm;
9 wt % of an SiC powder of which the grain size was less than 50 μm;
55 wt % of an SiC powder of which the grain size was less than 200 μm;
4 wt % of a calcined alumina powder sold by Almatis;
10 wt % of a reactive alumina powder sold by Almatis;
0.9 wt % of a temporary and plasticizing binder of the cellulose type; and
0.1 wt % of a deflocculant of the NaTPP type.

An amount of water corresponding to 10% of the weight of this mixture was added in order to obtain a cement of sufficient viscosity.

In this example, a different particle size distribution of the SiC grains was played with in order to reduce the porosity of the cement.

The characteristics of the crude structure and of the filter obtained after impregnation according to this example were approximately the same as those obtained for Example 1 and are given in Tables 1 and 2, the main differences being:
the porosity of the joint and coating cements in the crude structure was 36.5%, which corresponded to a porosity difference between the porosity of the filtering elements and the porosity of the cement of 22.3%; and
the porosity of the joint and coating cements in the filter (after impregnation) was this time 35%, which corresponded to a porosity difference between the porosity of the filtering elements and the porosity of the cement of 18.6%.

Chemical analysis showed a total Pt concentration of 48 g/ft³ (1.68 kg/m³), that is to say 4.2 grams spread over the various parts of the filter.

More precisely, the analysis revealed the following distribution:
0.25 wt % of platinum in the honeycomb elements, that is to say 4.0 grams, including 3.8 grams in the porosity of the walls of the honeycomb elements and 0.2 grams in the plugs;
0.08 wt % of platinum in the coating cement, namely 0.1 grams; and
0.05 wt % of platinum in the joint cement, namely 0.1 grams.

It can also be seen that by choosing the respective porosities of the various constituents of the filter, it is possible to achieve a substantial saving in Pt.

The comparison of the results obtained according to the Examples 1 and 2 show that the application of the process according to the invention makes it possible to save a not insignificant amount of catalyst and in particular of precious metal (0.3 grams per filter), thus generating a substantial saving in the overall cost of the process for depositing catalyst on the structure.

### EXAMPLE 2b

A catalytic filter was manufactured by repeating the same steps as those in Example 2, with the difference that the material used to make the plugs was not identical to the extrusion paste used for synthesizing the elements, but was a specific mixture resulting, after curing, in a lower porosity. The amounts of the various constituents of the mixture used were the following:
21 wt % of an SiC powder of which the grain size was less than 10 μm;
19 wt % of an SiC powder of which the grain size was less than 50 μm;
59 wt % of an SiC powder of which the grain size was less than 200 μm;
0.9 wt % of a temporary and plasticizing binder of the cellulose type; and
0.1 wt % of a deflocculant of the Na silicate type.

An amount of water corresponding to 15% of the weight of this mixture was added in order to obtain a mixture which was deposited at the end of the channels of the honeycomb elements, as described previously.

The characteristics of the crude structure and of the filter obtained after impregnation according to this example were approximately the same as those obtained for Example 1 and are given in Tables 1 and 2.

Chemical analysis showed a total Pt concentration of 47 g/ft³, that is to say 4.1 grams, spread over the various parts of the filter.

More precisely, the analysis revealed the following distribution:
0.24 wt % of platinum in the honeycomb elements, that is to say 3.9 grams, including 3.8 grams in the porosity of the walls of the honeycomb elements and 0.1 grams in the plugs;
0.08 wt % of platinum in the coating cement, namely 0.1 grams; and
0.05 wt % of platinum in the joint cement, namely 0.1 grams.

It can also be seen that by choosing the respective porosities of the various constituents of the filter, it is possible to achieve a substantial saving in Pt.

The comparison of the results obtained according to the Examples 1, 2 and 2b show that present process makes it possible to save an even greater amount of catalyst and in particular of precious metal (0.4 grams per filter), thus generating a substantial saving in the overall cost of the process for depositing catalyst on the structure.

It is fully understood that the present invention does not amount to this simple embodiment and that any known means for acting on the porosities of the cement and/or the filtering elements and/or their plugs, such as the introduction of fillers or sintering additives, must be considered as included within the scope of the present invention. Without departing from the scope thereof, it is also possible to use a combination of such means to exert an even better control over said porosity.

1. A process for obtaining a filter for filtering a gas loaded with soot particles and pollutants in the gas phase such as carbon monoxide CO, nitrogen oxides NOₓ, sulfur oxides SOₓ, hydrocarbons HC, said process comprising the steps of:
a) manufacturing a first structure comprising:
a central part comprising a plurality of filtering elements as a honeycomb connected together by a joint cement, said element or elements comprising a set of adjacent ducts or channels with axes parallel with one another separated by porous walls, which ducts are stopped by plugs at one or other of their ends to delimit inlet chambers opening on a gas intake face and outlet chambers opening on a gas discharge face, in such a way that the gas passes through the porous walls; and
a peripheral part made up of a coating cement protecting said element or elements, the porosity of the joint cement and/or of the coating cement and/or of the cement forming the plugs being less than the porosity of the material making up said walls; and
b) impregnating said structure with a solution comprising a catalyst precursor or the catalyst dissolved in a solvent such as water, that is to say a suspension of catalyst particles in a solvent such as water.

2. The process as claimed in claim 1, wherein said elements, the coating cement, the joint cement and the plugs are based on one and the same ceramic material.

3. The process as claimed in claim 1, wherein the porosity of the cement used for the coating and/or for the joint and/or for the plugs is at least 5%, lower than the porosity of the filtering elements.

4. The process as claimed in claim 1, wherein the porosity of the honeycomb filtering elements is between 30% and 70%.

5. The process as claimed in claim 1, wherein the porosity of the cement used for the coating and/or for the joint and/or for the plugs is between 20% and 60%.

6. The process as claimed in claim 1, wherein said impregnation is carried out by pumping the solution through the structure, by application of a vacuum or an under-pressure or under the pressure of the liquid comprising the impregnation solution over at least one end of the structure or by a combination of these various techniques.

7. The process as claimed in claim 1, wherein the porosity of the coating and/or joint cements and/or plugs is adjusted, during the step of manufacturing the structure, as a function of the composition of the cement and/or the particle size distribution of the grains and/or the amount of water mixed with grains and also that of the other liquid ingredients incorporated into the composition of said cement.

8. The process as claimed in claim 1, wherein the porosity of the coating and/or joint cements and/or plugs is adjusted by introducing, during the step of manufacturing the structure, a charge or filler, of which the size is adjusted to that of the pores

9. A catalytic filter obtained by the process as claimed in claim 1, wherein a porosity of the cement making up the coating and/or the joints and/or the plugs is lower than the porosity of the filtering element or elements, and a minimal amount of catalyst on said cement is present.

10. The catalytic filter as claimed in claim 9, wherein the porosity of the cement making up the coating and/or the joints and/or the plugs is at least 5% lower than the porosity of the filtering element or elements.

11. The process as claimed in claim 2, wherein the ceramic material is based on silicon carbide SiC.

12. The process as claimed in claim 1, wherein the porosity of the cement used for the coating and/or for the joint and/or for the plugs is at least 10% lower than the porosity of the filtering elements.

13. The process as claimed in claim 1, wherein the porosity of the cement used for the coating and/or for the joint and/or for the plugs is at least 15% lower than the porosity of the filtering elements.

14. The process as claimed in claim 1, wherein the porosity of the cement used for the coating and/or for the joint and/or for the plugs is at least 20% lower than the porosity of the filtering elements.

15. The process as claimed in claim 1, wherein the porosity of the honeycomb filtering elements is between 35% and 60%.

16. The process as claimed in claim 1, wherein the porosity of the cement used for the coating and/or for the joint and/or for the plugs is between 25% and 45%.

17. The process as claimed in claim 7, wherein dynamic compaction models are used.

18. The catalytic filter as claimed in claim 9, wherein the porosity of the cement making up the coating and/or the joints and/or the plugs is at least 10% lower than the porosity of the filtering element or elements.

19. The catalytic filter as claimed in claim 9, wherein the porosity of the cement making up the coating and/or the joints and/or the plugs is at least 15% lower than the porosity of the filtering element or elements.
